(19) United States
(12) Patent Application Publication
(10) Pub. No.: US 2006/0014122 A1
(43) Pub. Date: Jan. 19, 2006

(54) Method for qualifying and/or training a private customer for space flight

(76) Inventors: Eric Anderson, Arlington, VA (US); Robert Pearlman, Houston, TX (US)

Correspondence Address: VENABLE LLP, P.O. BOX 34385, WASHINGTON, DC, 20045-9998, US

(21) Appl. No.: 10/510,822

(22) PCT Filed: Apr. 10, 2003
(86) PCT No.: PCT/US03/10891

§ 371 Date: Aug. 1, 2005

(51) Int. Cl. G09B 19/16; G09B 9/08

(52) U.S. Cl. 434/30

(57) ABSTRACT

The present invention provides a method for qualifying a private customer for space flight. The method can include the steps of enrolling the private customer into a space flight qualification program and concluding the qualification program with certification for space flight. The space flight qualification program can include the steps of subjecting the private customer to medical evaluations, subjecting the private customer to exterior space-simulating environments, familiarizing the private customer with spacecraft interiors and equipment related to space flight, and qualifying said private customer for training and/or actual space flight based on successful completion of the qualification program.

### BACKGROUND OF THE INVENTION

1. Field of the Invention

The present invention relates generally to qualifying a private customer for space flight, and more particularly to qualifying the customer regardless of whether the customer actually flies in space.

2. Related Art

For over 40 years, space has been the realm of the elite few. Humanity watched and wondered when or if the ordinary person (e.g., non-career or generally highly trained astronaut, cosmonaut, or military personnel) would ever be able to fly into space. Recently, civilians have been able to “buy” their way into space by paying large sums of money (e.g., $20 million) for permission to accompany a team of astronauts into space. For most individuals desirous of recreational space flight this sum is cost prohibitive. Additionally, access to training facilities where private individuals can receive proper instruction on space flight equipment and instrumentation (including simulations of actual flight conditions) is scarce.

There is, therefore, a need for an affordable means of training and qualifying private individuals for space flight and for access to training and training facilities necessary to prepare private individuals for space flight, for qualification purposes, as a standalone space training educational activity, or as a recreational activity in and of itself, without being necessarily linked to actual space flight.

The inventors have worked for several years with the Russian Space Agency, RSC Energia, and the Yuri Gagarin Cosmonaut Training Center to develop private flights to the International Space Station (ISS). In April 2001, Space Adventures, Ltd. assisted with and facilitated the flight of the world's first privately funded space tourist, Dennis Tito. Space Adventures, Ltd. also represented Mark Shuttleworth, who flew to the International Space Station in April 2002. With a maximum of two tourist seats available each year, there is a demand for space flight qualification, experience, and training programs independent of and in excess of the opportunities for actual space flight.

### BRIEF SUMMARY OF THE INVENTION

The space flight process generally can be divided into three main components: qualification for space flight, space flight training, and actual space flight. Every private customer desiring to fly in space will likely have to qualify and train for space flight.

An embodiment of the present invention provides a method for qualifying a private customer for space flight. The method can include the steps of enrolling the private customer into a space flight qualification program and concluding the qualification program with certification for space flight. The space flight qualification program can include the steps of subjecting the private customer to medical evaluations, subjecting the private customer to simulated space environments, familiarizing the private customer with spacecraft interiors and equipment related to space flight, and qualifying said private customer for training and/or actual space flight based on successful completion of the qualification program.

Another embodiment of the present invention provides for a method of using a space flight training facility. The facility has a first apparatus for simulating exterior space environments, a second apparatus for familiarizing the private customer with spacecraft interiors and medical evaluation equipment. The method includes the steps of, for a private customer, using the first apparatus to subject the private customer to simulated space environment, using the second apparatus to familiarize the private customer with spacecraft interiors and equipment related to space flight, using the medical evaluation equipment to subject the private customer to a battery of medical tests, and qualifying the private customer for space flight based on successful use of the equipment independent of whether the private customer travels into space.

Yet another embodiment of the present invention provides for a method of space flight qualification having a step for enrolling a private customer, a step for determining the medical fitness of the private customer, a step for educating said private customer on aspects of space flight and engineering and dynamics related to space flight, a step for exposing the private customer to a microgravity environment for a predetermined duration, a step for exposing the private customer to at least one of increased and decreased gravity (G) forces to simulate gravity loads experienced during one of launch, space flight, and reentry, a step for subjecting said private customer to neutral buoyancy experiences and environment, and a step for providing certification of space flight qualification to the private customer upon completion of the previous steps. The method is performed independently of whether the private customer travels into space.

Further objectives and advantages, as well as the structure and function of preferred embodiments will become apparent from a consideration of the description, drawings, and examples.

### BRIEF DESCRIPTION OF THE DRAWINGS

The foregoing and other features and advantages of the invention will be apparent from the following, more particular description of a preferred embodiment of the invention, as illustrated in the accompanying drawings wherein like reference numbers generally indicate identical, functionally similar, and/or structurally similar elements.

FIG. 1 depicts a flow diagram of a method according to the present invention.

### DETAILED DESCRIPTION OF THE INVENTION

Embodiments of the invention are discussed in detail below. In describing embodiments, specific terminology is employed for the sake of clarity. However, the invention is not intended to be limited to the specific terminology so selected. While specific exemplary embodiments are discussed, it should be understood that this is done for illustration purposes only. A person skilled in the relevant art will recognize that other components and configurations can be used without parting from the spirit and scope of the invention. All references cited herein are incorporated by reference as if each had been individually incorporated. Provisional U.S. Patent Application No. 60/371,163, filed on Apr. 10, 2002, from which this application claims priority, is also incorporated herein by reference.

The following method can be used when qualifying a private customer for space flight. During the qualification process, an administering body, e.g., Space Adventures, Ltd. of Arlington, Va., USA (www.spaceadventures.com), can, for example, recruit a private customer, guide the private customer through the qualification process while monitoring the private customer's progress, and then evaluate the private customer to determine whether the private customer is qualified for space flight. After completing the qualification process, in one embodiment of the invention, the administering body may also administer training for space flight. In yet another embodiment of the invention, the administering body can transport the private customer on an actual space flight.

For example, in one embodiment of the invention, the private customer can enroll in the space flight qualification program for a fixed amount of days, for example, 10 days, and be qualified to train for space flight. The space flight training can then be completed independent of the qualification program, for example, over the next 6 months. Upon completion of the training, the private customer can then seek space flight. In another embodiment of the invention, the qualification and training program can be completed simultaneously over a period of, for example 10-14 days. Upon completion of the qualification/training program, the private customer can then take a space flight, such as, e.g., a sub-orbital space flight.

As referred to herein, a private customer can be any person, not employed as an astronaut, cosmonaut, or specialized flight person by a governmental space agency, government contractor, or military for the purpose of space flight or near space flight travel, who seeks space flight qualification for recreation, amusement, tourism, private research, or other similar purposes. In one embodiment of the invention, the private customer can be a paying customer who, for example, pays a fee for to seek qualification. In another embodiment, the private customer can be a non-paying customer who wins a contest, such as, e.g., a lottery, sweepstakes, televised or live game show, or the like. Alternatively, the non-paying customer can receive the opportunity to seek qualification through a gift, inheritance, redemption of frequent flier miles, or the like. In yet another embodiment, the private customer can be commercially or privately sponsored to seek qualification.

Space flight is intended to mean flight in a vehicle that attains altitudes over 100 kilometers (approximately 62.14 miles) from the Earth's surface. Examples of space flight can include without limitation, orbital and sub-orbital flight, or the like. Orbital flight is conventionally understood to encompass vehicles such as the Space Shuttle and International Space Station. To be orbital, the spacecraft or other vehicle must be travelling at a certain velocity, for example, 17,500 miles per hour. Sub-orbital flight refers to a vehicle reaching altitudes defined as space but without the necessary sustained velocity to achieve orbital flight. Thus, it is possible for a spacecraft or other vehicles to be in space, i.e., to achieve the requisite altitude, but not be in orbit because the spacecraft or other vehicle is not travelling at a high enough velocity. Sub-orbital vehicles, now planned, will become readily available for training, recreational, and transportation purposes in the coming years.

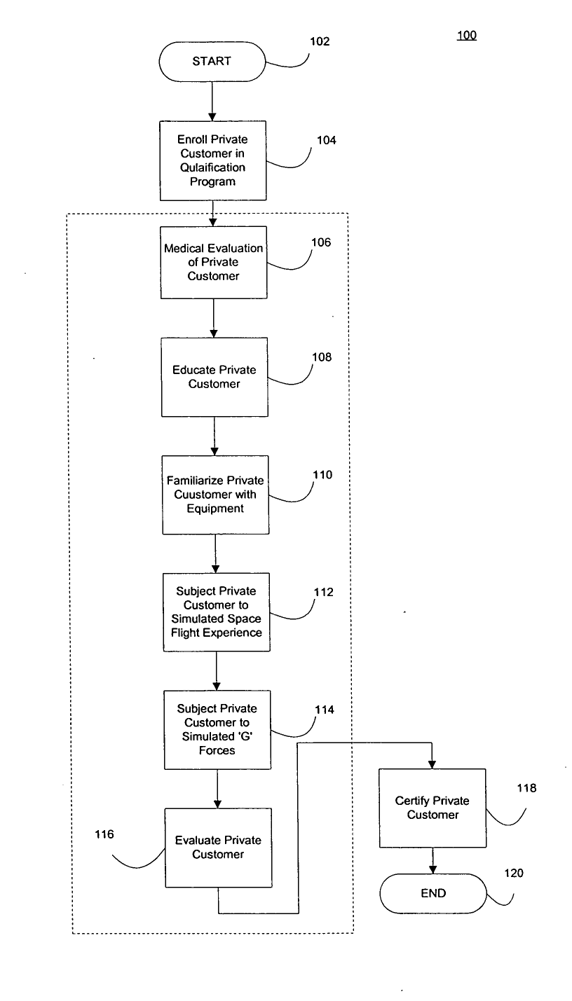

Referring now to the figure, FIG. 1 shows flow diagram 100 which illustrates the steps for qualifying a private customer for space flight. Flow diagram can begin with start step 102 and proceed to enrollment step 104. In enrollment step 104, the private customer can enroll in the qualification program. Enrollment step 104 can include having the private customer fill out an application and medical questionnaire and assessing the private customer based on his or her background, associations and/or motivations for desiring space travel. The application can be, for example, a written application, an online application, a telephone application or the like. In filling out the application, the private customer may be required to disclose any and all personal information including, but not limited to his or her name and address, date of birth, educational background, criminal record, professional/work experience, and the like. The medical questionnaire may require the private customer to disclose all relevant medical information including personal medical history, family medical history, and any other medical information. The medical questionnaire may also require the private customer to obtain a physical that is separate from the following medical evaluation step 106 to obtain information necessary to complete the medical questionnaire. In assessing the private customer, the certifying body, e.g., Space Adventures, can use information obtained during the enrollment process to evaluate the private customer to determine, for example, if the customer has the proper motivations for desiring space flight.

After completion of enrollment step 104, come the qualification steps (as indicated by the dashed box) of the space flight qualification program. The qualification steps of the space flight qualification program can include medical evaluation step 106, education step 108, flight related equipment familiarization step 110, simulated space environment step 112, simulated ‘G’-forces step 114, and evaluation step 116. The process ends with certification step 118. In one embodiment, the qualification steps can be completed in an order, for example, as shown in FIG. 1, or alternatively, can proceed in any order in a simultaneous or non-simultaneous manner with or without interruption. The qualification steps can also be completed in a fixed amount of time, for example, 3 or 10 days, or alternatively, can span over an undesignated amount of time, such as, e.g., 6 months to a year. The private customer may be free to enroll in a program of his or her choosing, or may be required to enroll in particular program depending on the private customer's goals with respect to achieving actual space flight. The qualification steps can be carried out at any space flight training facility, such as, for example, the Yuri Gagarin Cosmonaut Training Center.

Medical evaluation step 106 can include any thorough battery of tests sufficient to cause a trained professional to determine whether the private customer is fit for space flight. The battery of tests can include, without limitation, a complete blood analysis, a general exam by an otolaryngologist (ENT), a general exam by a neurologist, a general exam by a dentist, a general psychological exam by a psychologist, an electrocardiogram, an echocardiogram, an auditory system test, a passive posture test (topography diagnosis of blood system and cardiovascular systems, oscillography), a psychological screening, personality testing, determining the non-stop and continuous cumulating effects of Coriolis acceleration, determining the discontinuous cumulating effects of Coriolis acceleration, esophagigastroduodenascopic (Upper GI) series, a complete set of X-rays, 24-hours of electrocardiogram (EKG) monitoring, a colonoscopy, endoscopic ultrasonograph of inner organs, a spinal X-ray, and a visual exam.

During education step 108, the private customer can be educated about aspects of space flight to the extent necessary to evaluate suitability for space flight, including, but not limited to the physics of space flight, spacecraft operation, space station operation, orbital mechanics, astronomy, aeronautical engineering, and emergency procedures. The education of the private customer can be accomplished in several ways including without limitation lectures by spacecraft engineers, lectures by spacecraft architects, lectures by former and current cosmonauts/astronauts, lectures by test pilots, lectures by doctors and medical personnel, studying from books written on the subject of spacecraft operation, studying from books written on the subject of space flight, using computer software designed to instruct the private customer in orbital mechanics, using of computer software designed to instruct the private customer in flight profiles, and using a planetarium or celestial projection system.

During flight related equipment familiarization step 110, the private customer can be exposed to space flight related equipment to the extent necessary to evaluate suitability for space flight. The purpose of this step is to expose the private customer to the experience of the interior of their space flight vehicle including without limitation, the cockpit, passenger cabin, flight controls, cargo bay, and the like, as well as other equipment including without limitation the space suit and other non-spacecraft systems. The exposure can include, for example, being placed around and inside a stationary simulated spacecraft, and/or around and inside an actual spacecraft, training with computer systems designed to simulate spacecraft, and/or training with simulated components of a spacecraft, and/or training with actual components of a spacecraft, and/or training with simulated equipment used for space flight, and/or training with actual equipment and software used for space flight, and exposure to any other actual or simulated space flight related equipment.

During simulated space environment step 112, the private customer can be subject to simulation of the experiences of space flight, as well as other actual or simulated environments related to all aspects of space flight. The purpose of this step is to acclimate the private customer to the various environments of space flight, such as, e.g., changes in temperature, the claustrophobic nature of the spacecraft, changes in pressure inside the spacecraft, the lighting conditions, e.g., the lack of light inside the spacecraft, and emergency landing environments. The private customer can also be acclimated to the varying conditions of decreased and increased gravity as it relates to operations inside the spacecraft. For example, the private customer can be placed inside a jet aircraft at high altitudes, and/or around and inside a simulated spacecraft while the spacecraft is submerged under water, and/or around and inside an actual spacecraft while the spacecraft is submerged under water, and/or around and inside simulated spacecraft while inside an aircraft following a parabolic flight profile, and/or around and inside an actual spacecraft while inside an aircraft following a parabolic flight profile, and/or around and inside a simulated spacecraft while inside a hypobaric chamber, and/or around and inside an actual spacecraft while inside a hypobaric chamber, and/or around and inside an actual spacecraft while situated in launch configuration on a launch pad, and/or experiencing decompression inside a hypobaric altitude chamber, and/or experiencing hypoxia inside a hypobaric altitude chamber. Additionally, the private customer can conduct survival training in the desert, frozen tundra, forest, or water to simulate alternate emergency landing environments. These emergency landing environments can either be actual or simulated.

The space environment step 112 can include simulated ‘G’ forces or they can be provided in a separate step 114. During simulated ‘G’-forces step 114, the private customer can be subjected to various simulated ‘G’-forces, such as, e.g., increased and/or decreased ‘G’-forces and microgravity environments. Examples of these simulated ‘G’-forces can include without limitation, experiencing increased ‘G’-forces aboard a centrifuge, experiencing increased ‘G’-forces aboard a jet aircraft, experiencing increased and decreased ‘G’-forces aboard an aircraft flying a parabolic flight profile, experiencing decreased ‘G’-forces submerged in a tank and weighted to achieve neutral buoyancy, and experiencing decreased ‘G’-forces while skydiving from an aircraft.

During evaluation step 116, the administering body, alone or in conjunction with other organizations, can comprehensively evaluate the private customer to determine whether the private customer is qualified or unqualified for space flight based on the private customer's completion of any or all of the aforementioned steps. The criteria used to evaluate the private customer can be independently developed by the administering body or based on some other standard for space flight qualification, or the like.

During certification step 118, the administering body, e.g., Space Adventures, can certify that the private customer is qualified for space flight. If the private customer is not qualified for space flight, the administering body may choose not to certify the private customer for space flight. Certification step 118 can include, for example, the private customer receiving a certificate of achievement, receiving of a letter of rejection if the private customer is not qualified, receiving an award, i.e. wings, receiving a monetary award, receiving a physical or verbal invitation to continue training, receiving a contract for an actual space flight, receiving a compiled and edited video documenting the qualification process, presented in either DVD or similar format, and receiving an album of photographs of the qualification process. Upon completion of certification step 118, flow diagram 100 can end at step 120.

Space flight may not be available at a given time, for example due to the tragic loss of the Columbia space shuttle, or because suborbital vehicles are not widely available. Accordingly, an aspect of the invention involves taking payment from customers in advance, conducting qualification and possibly training according to the invention, and holding a place when it becomes available while holding the necessary customer funds in escrow.

Certification of suitability according to the invention has independent value as recognition that the customer has, as the popular saying goes, “the right stuff” to be an astronaut, whether or not the individual ever flies to space. Also, the qualification process of the invention, whether or not the customer receives certification, satisfies a demand for recreational, educational, and entertainment activities, such as being employed as part of a game show, and as shown in the following examples.

Suborbital Flight Program

In an embodiment involving sub-orbital flight, an administering agency such as Space Adventures makes sub-orbital space flight possible by collaborating with several independent corporations who are each developing their own version of a Reusable Launch Vehicle (RLV). Space tourism flights aboard these RLVs should begin within the next few years. Prior to the start of regular space tourism flights, each RLV is rigorously tested and licensed for operation in accordance with safety standards set by Space Adventures and all relevant local government regulations.

With the same anticipation and excitement that astronauts and cosmonauts experience before their orbital space launch, the flight specialists will help the customer don a flight suit and guide him or her through the final launch checklist. The launch will begin under the watchful eye of a pilot and/or precise control of system equipment. In an unprecedented sensory experience, rocket motors will boost the RLV beyond the normal limits of flight to regions above 62 miles (100 kilometers). As the RLV nears maximum altitude, the rocket engines will be shut down and allow the customer to experience up to five minutes of continuous weightlessness and see the vast blackness of space set against the blue limits of Earth below. To commemorate completion of this 30-90 minute space experience, Space Adventures, as an example of the administering body, will award, as an example, Space Adventures astronaut wings and a lifetime membership in the Exeo-Atmosphere Club, an exclusive private club for those who have experienced space flight first hand.

The sub-orbital flights are preceded by a detailed four-day flight preparation and training program. This highly focused and inspiring pre-flight program familiarizes the customer with the RLV flight program, critical vehicle systems, flight operations, zero-gravity training, in-flight gravity loads, and space flight safety procedures. Specifically, created under the direction of expert advisors and aerospace specialists, the flight-training program is derived from the experiences and lessons learned in preparing both astronauts and cosmonauts for space flight. The primary objective of the training focuses on ensuring safety and maximizing enjoyment once in-flight. An exemplary schedule is as follows.

Day One: Meet Flight Team

Morning
Breakfast
Program briefing and orientation
Health screening by staff Flight Surgeon

Afternoon
Space Adventures sponsored lunch
Introduction to fellow flight program participants and flight crew
Briefing on the flightsuit's safety features, operation and fitting of your flight suit
Photo session: Flight Team photo session with flight crew
Tour and operations briefing on Spaceport
Briefing on astronaut and cosmonaut training philosophies
Training session on zero gravity, including its effects, flight characteristics, and flight enhancement pointers

Evening
Flight Team four course dinner and entertainment
Optional astronomy presentation and viewing, with the chance to enjoy the brilliant night sky through a state-of-the-art telescope.
   Day Two: Sub-Orbital Vehicle & Safety Training

Morning
Breakfast
Program briefing presentation question/answer session
Tour of reusable launch vehicle (RLV)
Training and briefing on RLV safety procedures and systems
Inspection and briefing on RLV propulsion systems, reaction control systems and sub-orbital flight mechanics/profile
Training aboard centrifuge to simulate gravity loads experienced during the sub-orbital flight
Final health certification for flight

Afternoon
Lunch
Program briefing on the upper-orbital space environment
Briefing and operations of inter-cabin communications and the health monitoring devices
Flight couch customization-and-fit check aboard RLV, familiarization with RLV interior and exterior camera personal console operations
Familiarization of science payload operations

Evening
Pre-Spaceflight Dinner Gala
Feature entertainment and post-dinner optional activities
   Day Three: Flight Simulation

Morning
Program briefing on zero gravity RLV simulator aboard zero gravity training aircraft. The Flight Team will experience virtual reality simulations of the sub-orbital flight during parabolic flight training exercises. Debriefing on zero gravity training flight.
Brunch
Simulations include in-flight aborts, camera and science payload operations
Safety training review aboard RLV
Review and operation of inter-cabin communications and health monitoring devices
Review of RLV interior and exterior cameras and personal console operations
Review of science payload operations
Selection of science payload specialist and team leader by training staff

Afternoon
Optional activities

Evening
Sponsored dinner
Feature presentation: Space Tourism: The Next 20 Years
Following dinner: participate in an interactive astronomy session
   Day Four: Liftoff from Earth to Space

Morning
Traditional Astronaut Steak and Eggs Breakfast (vegetarian options available)
Program pre-flight briefing
Following breakfast:
   RLV inspection with flight crew
   Suit up and emergency life support systems check
   Video/photo session with launch vehicle
   Final safety training review aboard RLV
   Review pre-flight checklist with flight crew through intercom system.

Afternoon
Main Events of Countdown and Launch of RLV
Flight Team experiences all phases of propulsion system boost, travels over twice the speed of sound and feels the gravity load increase as the RLV accelerates through the beginning of its 30-90 minute sub-orbital space flight.
View limits of Earth, and the vastness of the universe beyond Earth's atmosphere at an altitude of over 62 miles (100 km).
Flight Team creates their own customized video of the astronaut experiences using interior and exterior camera array on RLV.
Science Payload Specialist activates scientific sampling and monitoring experiments
Experience up to five minutes of continuous weightlessness while “free-floating” in cabin
Observe the RLV ionization glow during hypersonic re-entry and feel the gravity load increase as the vehicle decelerates in the atmosphere
Landing Celebration: Flight Team is greeted by family, friends and staff following sub-orbital landing
Review of raw video footage from flight for editing and customization of personalized flight videos

Evening
Gala
Reception and Awards Dinner, black tie optional
Special induction ceremony honoring the Flight Team. Presentation of Astronaut Wings. Flight Team is inducted into a private club.
   Orbital Flight Qualification Program

In another embodiment of the invention, a private customer can qualify to fly to the International Space Station (ISS) without having to be a career astronaut or cosmonaut. Space Adventures has worked since August 1999 with the Russian Space Agency, RSC Energia, and the Yuri Gagarin Cosmonaut Training Center to develop private flights to the ISS. A private customer who has the determination, resources, and can meet the requirements may be able to join the elite group of space explorers.

An example of an orbital qualifications program (OQP) includes:

full cosmonaut medical certification
chartered zero gravity flight
MiG-25 and 29 supersonic flights
neutral buoyancy and Soyuz spacecraft training
NOMEX flight suit and leather flight jacket
all transfers, meals, tours, and executive suite accommodations at the five-star Sheraton Palace Hotel
VIP processing, guides, staff support and interpreters
   OQP Prerequisites:
Current medical history and documentation prior to medical exam
Medical certification from physician for MiGs and Zero Gravity flights
Diving certification for neutral buoyancy
   Details:
Participants must be availabile for two weeks of medical examination and training in Moscow.
All medical examinations and tests will be conducted at IMBP facilities in Moscow.
Cosmonaut training activities will be conducted at the Yuri Gagarin Cosmonaut Training Center in Star City.
Additional tours are scheduled after daily required activities as the schedule allows.

Itinerary

Individuals wishing to embark on a Soyuz space flight need to be flight certified by the Russian Space Agency. Space Adventures offers an Orbital Flight Qualification Package to anyone wishing to participate in a space flight experience. This approach involves the technical facilities of the Yuri Gagarin Cosmonaut Training Center (Star City) and the State Research Center of the Russian Federation Institute of Biomedical Problems (IMBP). An exemplary itinerary is as follows.

Day One: VIP transfer from airport to the five-star Sheraton Palace Hotel in downtown Moscow. Dinner and orientation

Day Two: Driving tour of the major highlights of Moscow. After lunch, transfer to Star City for a tour of the Yuri Gagarin Cosmonaut Training Center.

Day Three: Comprehensive medical exam begins. Over the next several days the customer experiences one of the most thorough medical exams of his or her life. Complete blood tests, heart tests, neurological tests, dental tests, auditory tests, and comprehensive body scans. Other highlights include:
non-stop and continuous cumulating effects of Coriolis acceleration
discontinuous cumulating of Coriolis accelerations
4-8 Gs inside TsF-18 Centrifuge
Hypobaric Altitude chamber
   Day Eleven: Transfer to Star City for chartered Zero-Gravity flight. Usually 12 people are taken up at a time, but this can be a private trip for the customer. Soyuz Simulator training in the afternoon with practice docking with the ISS.
   Day Twelve: The committee gives their summary and conclusions on cosmonaut medical certification. Customer is then transfered to Zhukovsky Air Base for MiG-25 and MiG-29 flights.
   Day Thirteen: Transfer to Star City for a full day Neutral Buoyancy training using the Orlan-M spacesuit. In the evening, celebrate accomplishments at special dinner in your honor.
   Day Fourteen Check out of hotel. VIP transfer and departure processing at the airport.
   Availability of ISS Flights:

This OQP provides the customer with an understanding of the challenges to be faced and qualification as to whether the customer meets the prerequisites. This can lead to arrangements for orbital space flight, if the opportunity arises and the customer decides to pursue it. The final medical examinations and qualification procedures are stringent, and the training sessions are physically and mentally demanding. Not everyone was meant to fly into space, but as we pass the 40th anniversary of the first manned space flight, according to the invention, private citizen explorers have the opportunity to qualify to visit an orbiting space station.

The embodiments illustrated and discussed in this specification are intended only to teach those skilled in the art the best way known to the inventors to make and use the invention. Nothing in this specification should be considered as limiting the scope of the present invention. All examples presented are representative and non-limiting. The above-described embodiments of the invention may be modified or varied, without departing from the invention, as appreciated by those skilled in the art in light of the above teachings. It is therefore to be understood that, within the scope of the claims and their equivalents, the invention may be practiced otherwise than as specifically described.

What is claimed is:

1. A method of qualifying a private customer for space flight, comprising the steps of:
enrolling the private customer into a space flight qualification program;
administering a space flight qualification program comprising the steps of:
subjecting the private customer to medical evaluations related to space flight;
subjecting the private customer to simulated space environments;
familiarizing the private customer with spacecraft interiors and equipment related to space flight; and
evaluating the private customer as qualified or unqualified for training and/or actual space flight based on successful completion of the space flight qualification program; and
concluding the qualification program with certification of the private customer for space flight, wherein the method of qualifying is independent of flying the private customer into space.

2. The method according to claim 1, further comprising:
subjecting the private customer to increased and/or decreased gravity (G) forces to simulate gravity.

3. The method according to claim 1, further comprising:
educating the private customer regarding space flight and/or spacecraft operation.

4. The method according to claim 1, further comprising:
training the private customer for space flight.

5. The method according to claim 4, wherein the training is for sub-orbital space flight.

6. The method according to claim 4, wherein the training is for orbital space flight.

7. The method according to claim 4, further comprising:
transporting the private customer on a space flight.

8. The method according to claim 7, wherein the space flight is a sub-orbital space flight.

9. The method according to claim 1, wherein the space flight is an orbital space flight.

10. The method according to claim 1, wherein the space flight qualification has a duration of about two weeks.

11. A method of using a space flight training facility, the facility comprising a first apparatus for simulating exterior space environments, a second apparatus for familiarizing the private customer with spacecraft interiors and medical evaluation equipment, the method comprising, for a private customer:
using the first apparatus to subject the private customer to exterior space-simulating environment;
using the second apparatus to familiarize the private customer with spacecraft interiors and equipment related to space flight;
using the medical evaluation equipment to subject the private customer to a battery of medical tests; and
qualifying the private customer for space flight based on successful use of the equipment independent of whether the private customer travels into space.

12. The method according to claim 11, the method further comprising:
using an apparatus to subject the private customer to increased and/or decreased gravity (G) forces to simulate gravity.

13. The method according to claim 11, the method further comprising:
using educational facilities to educate the private customer regarding space flight and/or spacecraft operation.

14. The method according to claim 11, the method further comprising:
using the first and second apparatus to train the private customer for space flight.

15. The method according to claim 14, wherein the private customer is trained for sub-orbital space flight.

16. The method according to claim 14, wherein the private customer is trained for orbital space flight.

17. The method according to claim 14, further comprising:
transporting the private customer on a space flight.

18. The method according to claim 17, wherein the space flight is a sub-orbital space flight.

19. The method according to claim 11, wherein the space flight is an orbital space flight.

20. The method according to claim 11, wherein the method is carried out over a duration of about two weeks.

21. A method of space flight qualification comprising:
a step for enrolling a private customer
a step for determining the medical fitness of the private customer;
a step for educating said private customer on aspects of space flight and engineering and dynamics related to space flight;
a step for exposing the private customer to a microgravity environment for a predetermined duration;
a step for exposing the private customer to at least one of increased and decreased gravity (G) forces to simulate gravity loads experienced during one of launch, space flight, and reentry;
a step for subjecting said private customer to neutral buoyancy experiences and environment; and
a step for providing certification of space flight qualification to the private customer upon completion of the previous steps,
wherein the method is performed independently of whether the private customer travels into space.
